(19) United States
(12) Patent Application Publication
(10) Pub. No.: US 2011/0066987 A1
(43) Pub. Date: Mar. 17, 2011

(54) LAYOUT METHOD, LAYOUT DEVICE, AND NON-TRANSITORY COMPUTER READABLE MEDIUM STORING LAYOUT PROGRAM

(75) Inventor: Mitsuru Handa, Kanagawa (JP)

(73) Assignee: Renesas Electronics Corporation

(21) Appl. No.: 12/881,724

(22) Filed: Sep. 14, 2010

(30) Foreign Application Priority Data
Sep. 16, 2009 (JP) 2009-214087

(51) Int. Cl. G06F 17/50

(52) U.S. Cl. 716/104

(57) ABSTRACT

A layout method in accordance with an exemplary aspect of the present invention performs layout of a semiconductor integrated circuit, the layout method including: performing logic synthesis without inserting at least one clock gating cell among clock gating cells inserted in the semiconductor integrated circuit; laying out a cell according to a result of the logic synthesis; inserting the clock gating cell not inserted in the logic synthesis after the cell is laid out; and laying out the inserted clock gating cell, and structuring a clock tree.

### INCORPORATION BY REFERENCE

This application is based upon and claims the benefit of priority from Japanese patent application No. 2009-214087, filed on Sep. 16, 2009, the disclosure of which is incorporated herein in its entirety by reference.

### BACKGROUND

1. Field of the Invention

The present invention relates to a layout method, a layout device, and a non-transitory computer readable medium storing a layout program, and more particularly, to layout of a semiconductor integrated circuit.

2. Description of Related Art

In recent years, the power consumption of a semiconductor integrated circuit has been increasing with a large scale semiconductor integrated circuit. Thus, a semiconductor integrated circuit mounts a clock gating circuit for low power consumption.

Japanese Unexamined Patent Application Publication No. 2007-072995 discloses a technique to reduce the power consumption by controlling position or the like in which a clock gating circuit is laid out. Hereinafter, a layout device disclosed in Japanese Unexamined Patent Application Publication No. 2007-072995 is described with reference to FIG. 4 and FIG. 5. FIG. 4 is a block diagram that shows a configuration of the layout device disclosed in Japanese Unexamined Patent Application Publication No. 2007-072995.

A layout device 301 disclosed in Japanese Unexamined Patent Application Publication No. 2007-072995 includes an information reading unit 302, a floor plan performing unit 303, a layout/CTS (Clock Tree Synthesis)/optimization unit 304, a LOCKUP cell deleting/inserting unit 305, a timing optimizing unit 306, and a signal wiring unit 307. The layout/CTS/optimization unit 304 includes a clock line recognizing unit 341, a clock gating circuit recognizing unit 342, a clock gating circuit deleting unit 343, an other circuit laying out/optimizing unit 344, a clock gating circuit merging/dividing unit 345, and a clock gating circuit layout/CTS performing unit 346.

FIG. 5 is a flow chart showing processing of the layout device shown in Japanese Unexamined Patent Application Publication No. 2007-072995.

First, the information reading unit 302 reads a design rule, a library, an RTL (Register Transfer Level) or a netlist, and a timing constraint (S401, S402).

Next, the floor plan performing unit 303 decides position in which an I/O (Input Output) is laid out, chip size, and position in which a hard macro is laid out (S403).

Next, the clock line recognizing unit 341 recognizes a clock line in a circuit that will be created (S404).

Next, the clock gating circuit recognizing unit 342 checks whether there is a combinational circuit corresponding to a clock gating circuit on the recognized clock line (S405). Note that, whether a combinational circuit is a clock gating circuit is determined by whether a clock signal is definitely transmitted to the subsequent stage of the circuit, or whether the circuit is stopped by an enable signal. In addition, a cell that becomes a hard macro like an ICG (Integrated Clock Gating Cell) can be determined by the cell name.

When there is no clock gating circuit, the other circuit laying out/optimizing unit 344 performs layout, CTS, and optimization (S406).

When there is a clock gating circuit, the clock gating circuit deleting unit 343 deletes the clock gating circuit from an initial layout target (S407).

Next, the other circuit laying out/optimizing unit 344 lays out cells other than the clock gating circuit on the clock line (S408).

Next, the clock gating circuit merging/dividing unit 345 merges or divides the clock gating circuit on the clock line (S409).

Next, the clock gating circuit layout/CTS performing unit 346 performs layout of the clock gating circuit on the clock line and structure of a clock tree to achieve low power consumption while adjusting clock skew (S410). At this time, the clock gating circuit is laid out in the first stage near a clock root, which eliminates the need to structure the clock tree in front of the clock gating circuit. As a result, it is possible to reduce the power consumption of cell constituting the clock tree. Henceforth, the LOCKUP cell deleting/inserting unit 305 performs processing for LOCKUP cell (S411-S414). The timing optimizing unit 306 optimizes timing after the clock tree is structured (S415). The signal wiring unit 307 wires signal wire (S416). Then, the layout is completed.

In this way, Japanese Unexamined Patent Application Publication No. 2007-072995 solves the problem that adjusting clock skew becomes difficult or impossible since a clock gating circuit is laid out near a synchronous circuit such as a flip-flop.

However, the technique disclosed in Japanese Unexamined Patent Application Publication No. 2007-072995 has a problem that it takes long time to perform each step of the clock line recognizing unit 341, the clock gating circuit recognizing unit 342, and the clock gating circuit deleting unit 343 of the layout/CTS/optimization unit 304 (hereinafter, these three steps are collectively referred to as “clock gating circuit recognizing/deleting step”). The reason is described below.

In the technique disclosed in Japanese Unexamined Patent Application Publication No. 2007-072995, when a clock gating circuit is evaluated according to the presence or absence of an enable signal input to a combinational circuit on a clock line, the clock gating circuit recognizing/deleting step is repeatedly performed for the number of times corresponding to the number of enable signals input to the combinational circuits on clock lines. Thus, in a semiconductor integrated circuit, if time required for the clock gating circuit recognizing/deleting step is X hours, and the number of enable signals input to the combinational circuits on clock lines is Y, time required for the clock gating circuit recognizing/deleting step for the whole semiconductor integrated circuit is X×Y hours. That is, time required for the clock gating circuit recognizing/deleting step increases in proportion to the number of enable signals input to the combinational circuit on clock lines. By the way, in recent years, the number of clock gating circuits and enable signals controlling output of the clock gating circuits has been increasing with a large scale semiconductor integrated circuit. According to this, the present inventor has found a problem that time required for the clock gating circuit recognizing/deleting step greatly increases.

Furthermore, in the technique disclosed in Japanese Unexamined Patent Application Publication No. 2007-072995, when a clock gating circuit is evaluated according to the cell name, the clock gating circuit recognizing/deleting step is repeatedly performed for the number of times corresponding to the number of clock gating circuits. Note that, each of clock gating circuits receives an enable signal. Thus, even when a clock gating circuit is evaluated according to the cell name, time required for the clock gating circuit recognizing/deleting step increases in proportion to number of enable signals input to the combinational circuit on clock lines.

A clock gating circuit and an enable signal controlling output output from the clock gating circuit can be arbitrarily inserted in a semiconductor integrated circuit. Thus, a lot of clock gating circuits and enable signals controlling the output output from the clock gating circuits are inserted in the semiconductor integrated circuit having large scale and complex clock control function. As a result, time required for the clock gating circuit recognizing/deleting step increases without limit.

Meanwhile, Japanese Unexamined Patent Application Publication No. 2007-114986 discloses a technique that presumes voltage drop area after cells are laid out in advance in consideration of positional relation of cells on a chip and operating frequency influencing power consumption of cells, and prevents voltage drop by re-laying out cells in the presumed voltage drop area, in a semiconductor integrated circuit. This enables to eliminate the step regarding re-laying out and wiring performed after the voltage drop is refined. However, Japanese Unexamined Patent Application Publication No. 2007-114986 does not disclose a specific technique that can reduce the time for processing that controls position of clock gating cell to reduce power consumption.

### SUMMARY

As explained in the related arts, in the technique disclosed in Japanese Unexamined Patent Application Publication No. 2007-114986, the present inventor has found a problem that it takes long time to perform processing that controls position of clock gating cell to reduce power consumption.

A first exemplary aspect of the present invention is a layout method to perform layout of a semiconductor integrated circuit, the layout method including: performing logic synthesis without inserting at least one clock gating cell among clock gating cells inserted in the semiconductor integrated circuit; laying out a cell according to a result of the logic synthesis; inserting the clock gating cell not inserted in the logic synthesis after the cell is laid out; and laying out the inserted clock gating cell, and structuring a clock tree.

A second exemplary aspect of the present invention is a layout device to perform layout of a semiconductor integrated circuit, the layout device including: a logic synthesis unit that performs logic synthesis without inserting at least one clock gating cell among clock gating cells inserted in the semiconductor integrated circuit; a cell laying out unit that lays out a cell according to a result of the logic synthesis; a clock gating cell inserting unit that inserts the clock gating cell not inserted in the logic synthesis after the cell is laid out by the cell laying out unit; and a clock gating cell layout/tree structure performing unit that lays out the clock gating cell inserted by the clock gating cell inserting unit, and structures a clock tree.

A third exemplary aspect of the present invention is a non-transitory computer readable medium storing a layout program performing layout of a semiconductor integrated circuit, the layout program causing a computer to execute the processing of: performing logic synthesis without inserting at least one clock gating cell among clock gating cells inserted in the semiconductor integrated circuit; laying out a cell according to a result of the logic synthesis; inserting the clock gating cell not inserted in the logic synthesis after the cell is laid out; and laying out the inserted clock gating cell, and structuring a clock tree.

According to each of the above-mentioned exemplary aspects, there is need to perform the clock gating circuit recognizing/deleting step because a clock gating cell is not inserted in the logic synthesis. Thus, it is possible to reduce processing time. Furthermore, each of the above-mentioned exemplary aspects inserts the clock gating cell after a standard cell is laid out, and then lays out the clock gating cell and structures a clock tree. Thus, it is possible to control position of the clock gating cell to achieve low power consumption, and structure the clock tree.

According to each of the above-mentioned exemplary aspects of the present invention, it is possible to provide a layout method, a layout device, and a non-transitory computer readable medium storing a layout program that are capable of reducing processing time to control position of a clock gating cell to reduce power consumption.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing a configuration of a layout device in accordance with an exemplary embodiment of the present invention;

FIG. 2A is a diagram showing an example of a basic file format of a control information file in accordance with an exemplary embodiment of the present invention;

FIG. 2B is a diagram showing a specific example of output of a control information file in accordance with an exemplary embodiment of the present invention;

FIG. 3 is a flowchart showing processing of a layout device in accordance with an exemplary embodiment of the present invention;

FIG. 4 is a block diagram showing a configuration of a layout device in accordance with a related art; and

FIG. 5 is a flowchart showing processing of a layout device in accordance with a related art.

### DETAILED DESCRIPTION OF THE EXEMPLARY EMBODIMENTS

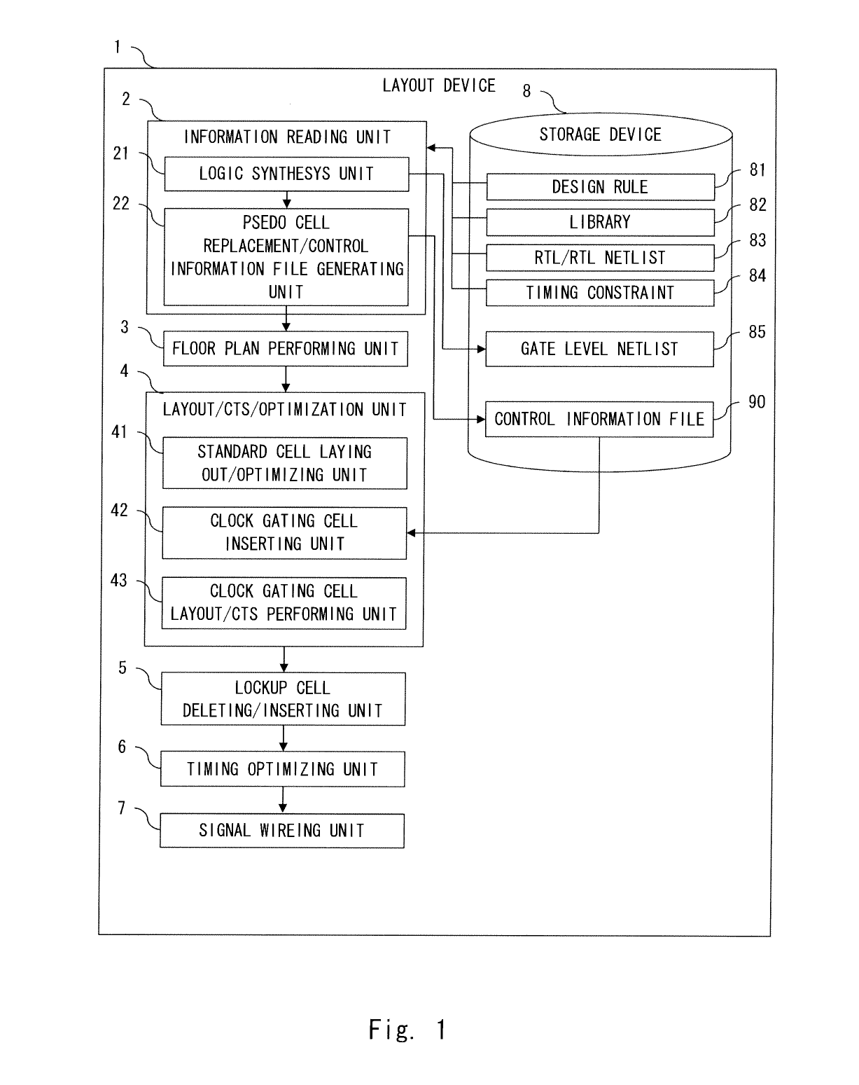

A configuration of a layout device in accordance with an exemplary embodiment of the present invention is explained with reference to FIG. 1. FIG. 1 is a block diagram showing a configuration of a layout device in accordance with an exemplary embodiment of the present invention.

A layout device 1 includes an information reading unit 2, a floor plan performing unit 3, a layout/CTS/optimization unit 4, a LOCKUP cell deleting/inserting unit 5, a timing optimizing unit 6, a signal wiring unit 7, and a storage device 8. For example, the layout device 1 is an information processing device such as a PC (Personal Computer) and a server. For example, the layout device 1 includes hardware such as a CPU (Central Processing Unit) and a memory. The layout device 1 performs processing by the hardware. The layout device 1 generates a layout data indicating layout in a semiconductor integrated circuit by laying out the semiconductor integrated circuit according to input data.

The information reading unit 2 includes a logic synthesis unit 21 and a pseudo cell replacement/control information file generating unit 22. The layout/CTS/optimization unit 4 includes a standard cell laying out/optimizing unit 41, a clock gating cell inserting unit 42, and a clock gating cell layout/CTS performing unit 43.

Next, each of the elements of the above-mentioned layout device is explained.

The information reading unit 2 reads information such as a design rule 81, a library 82, an RTL/RTL netlist 83, and a timing constraint 84.

The floor plan performing unit 3 performs floor plan according to information read by the information reading unit 2.

The layout/CTS/optimization unit 4 lays out a circuit, structures a clock tree, and optimizes layout of a circuit.

The LOCKUP cell deleting/inserting unit 5 deletes or inserts LOCKUP cell inserted for DFT (Design For Testability).

The timing optimizing unit 6 optimizes timing according to content of the timing constraint 84 that includes information indicating setup time, hold time, and so on.

The signal wiring unit 7 wires signal wire.

The storage device 8 stores the design rule 81, the library 82, the RTL/RTL netlist 83, the timing constraint 84, a gate level netlist 85, and a control information file 90. The information 81-85, 90 is stored in the storage device 8 as files of arbitrary format. For example, the storage device 8 is a hard disk, a nonvolatile memory, and so on.

The logic synthesis unit 21 performs logic synthesis according to information read by the information reading unit 2. Furthermore, the logic synthesis unit 21 generates gate level netlist that is a result of the logic synthesis. The logic synthesis unit 21 stores the generated gate level netlist in the storage device 8. RTL netlist is information that indicates RTL as gate level. The gate level netlist is information that indicates RTL as gate level and includes information indicating library that is to be used and so on. The logic synthesis unit 21 can perform the logic synthesis according to information of either RTL or RTL netlist.

The pseudo cell replacement/control information file generating unit 22 replaces a control target flip-flop targeted for control by an enable signal with a pseudo cell. Furthermore, the pseudo cell replacement/control information file generating unit 22 creates the control information file 90 indicating information in which the enable signal corresponds to the control target flip-flop controlled by the enable signal. Note that, the control target flip-flop is the flip-flop in which input data is controlled by the enable signal.

The standard cell laying out/optimizing unit 41 lays out and optimizes a circuit constituting a standard cell. Note that, the standard cell is a cell excluding a clock gating cell. The clock gating cell is composed of a clock gating circuit.

The clock gating cell inserting unit 42 inserts a clock gating cell on a clock line in consideration of layout of a standard cell.

The clock gating cell layout/CTS performing unit 43 lays out a clock gating cell, and structures clock tree.

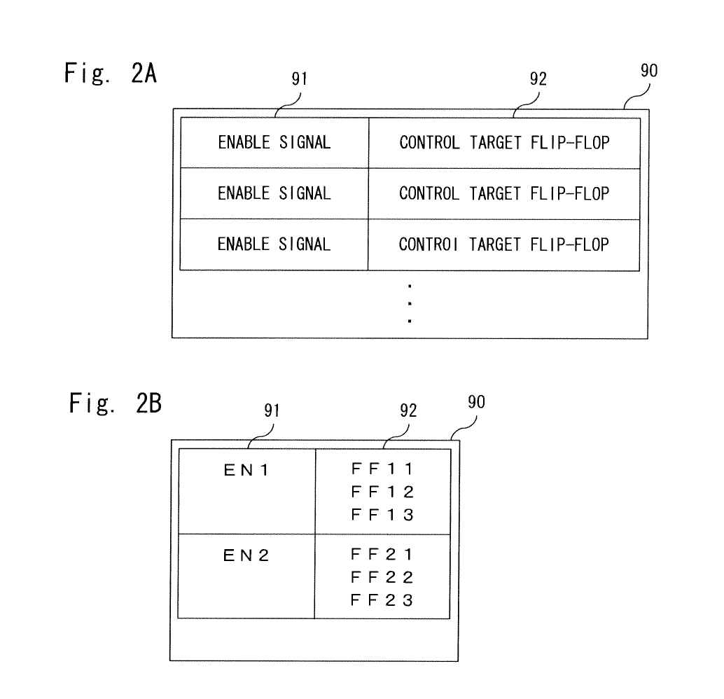

Next, an example of a basic file format of a control information file in accordance with the exemplary embodiment of the present invention is explained with reference to FIG. 2A. FIG. 2A is a diagram showing an example of a basic file format of a control information file in accordance with the exemplary embodiment of the present invention.

FIG. 2A shows a basic format of the control information file 90.

The control information file 90 includes a plurality of information blocks. The information block is the information in which an enable signal 91 corresponds to a control target flip-flop 92 controlled by the enable signal 91. Specifically, the control information file 90 is control information in which correspondence of the name of the enable signal 91 and an instance name of the control target flip-flop 92 controlled by the enable signal 91 is listed. The control information file 90 includes one information block for each of enable signals. Thus, the control information file 90 includes information blocks corresponding to the number of the enable signals. Note that, the name of the enable signal 91 means the name decided uniquely for each of enable signals. Furthermore, the instance the name is name decided uniquely for each of control target flip-flops.

FIG. 2B shows a specific example of output of the control information file 90.

In FIG. 2B, “EN1” and “EN2” indicate names of enable signals 91. In FIG. 2B, “FF11”-“FF13” and “FF21”-“FF23” indicate instance names of the control target flip-flops 92.

FIG. 2B shows that the data input to the flip-flops FF11, FF12, and FF13 is controlled by the enable signal EN1. Furthermore, FIG. 2B shows that the data input to the flip-flops FF21, FF22, and FF23 is controlled by the enable signal EN2.

In this way, the control information file 90 includes an enable signal name and an instance name of a control target flip-flop controlled by the enable signal in the same the information block. Thus, the control information file 90 is information to determine which enable signal controls a clock signal input to which control target flip-flop, when a clock gating circuit is inserted. Note that, when the number of enable signals included in a semiconductor integrated circuit is one, the combination of an enable signal name and an instance name of a control target flip-flop, which is control information, is decided uniquely. Thus, in this case, creation of the control information file 90 may be omitted.

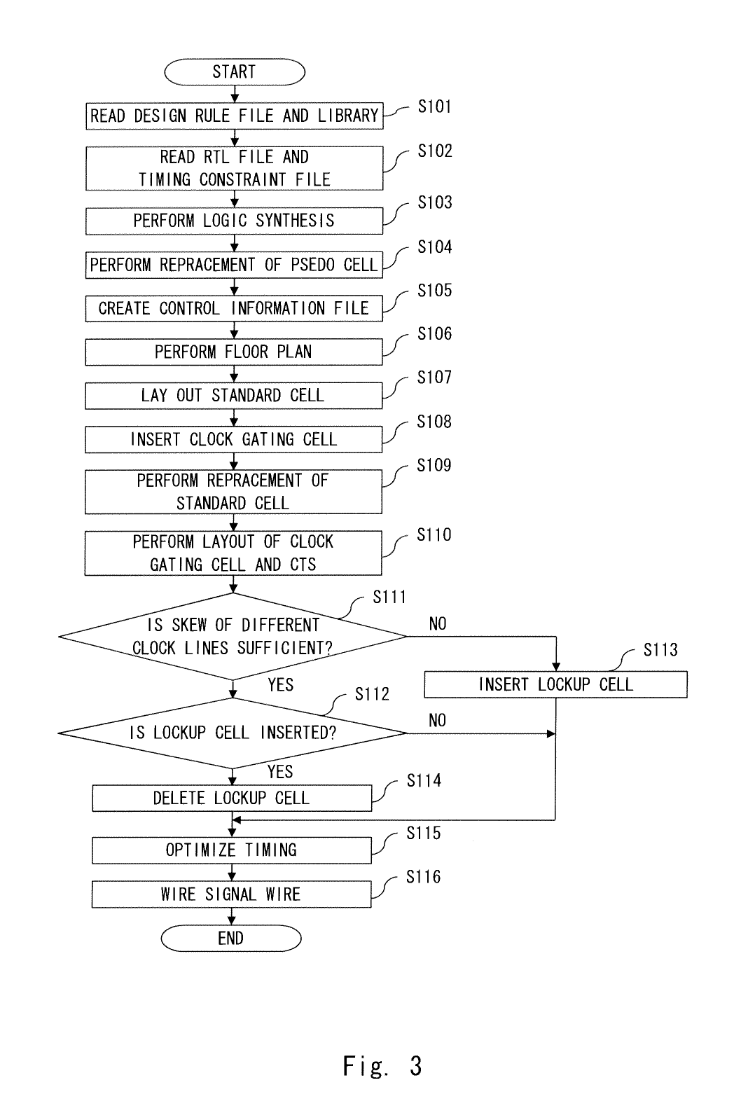

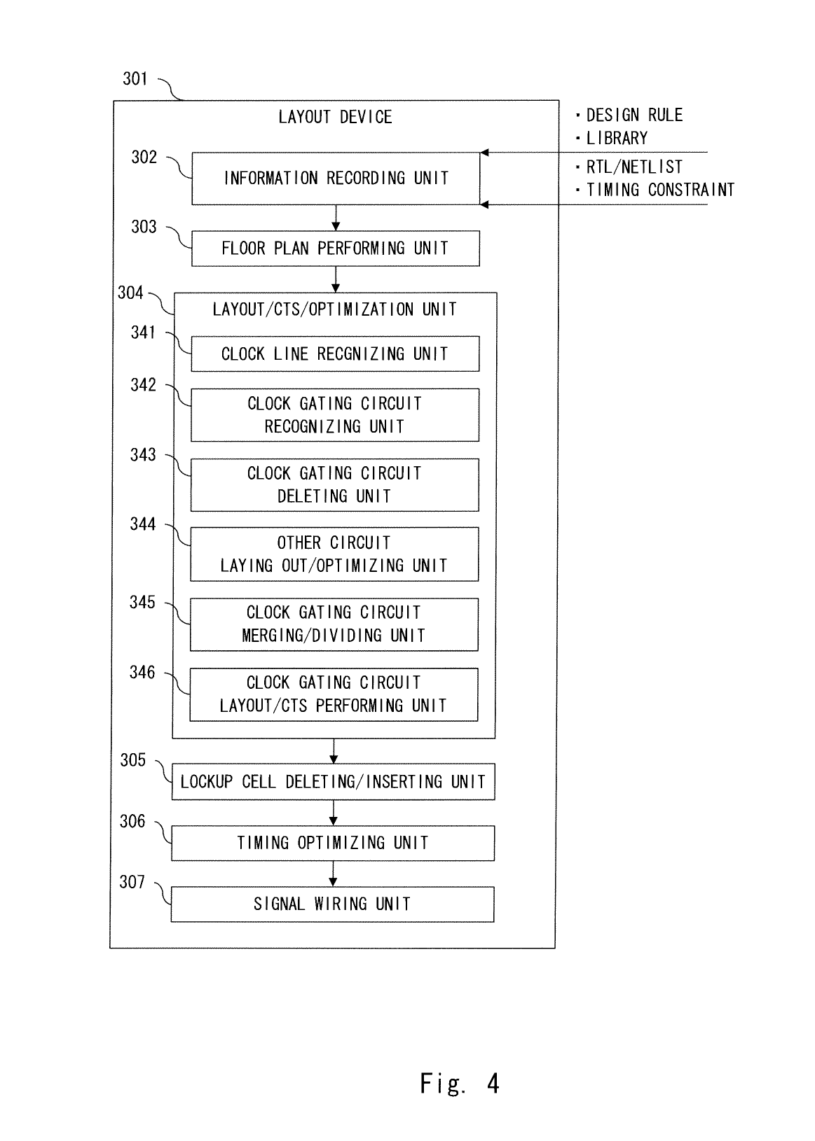

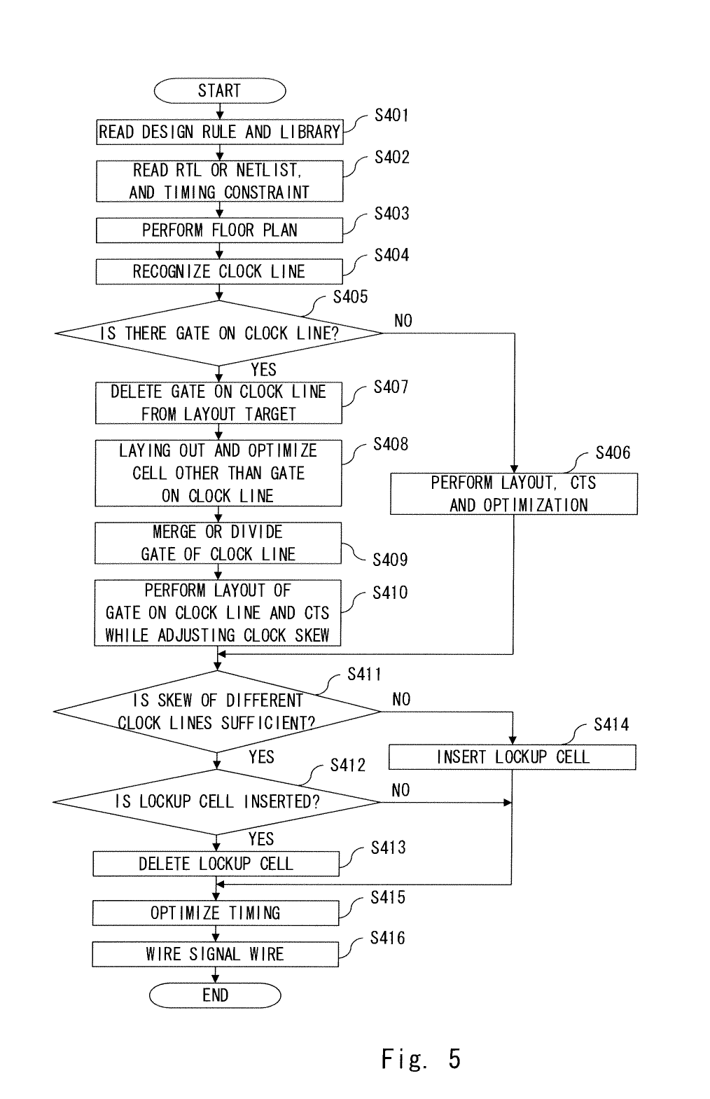

Processing of a layout device in accordance with the exemplary embodiment of the present invention is explained with reference to FIG. 3. FIG. 3 is a flowchart showing processing of a layout device in accordance with the exemplary embodiment of the present invention.

The logic synthesis unit 21 of the information reading unit 2 reads the design rule file 81 and the library file 82 stored in the storage device 8 (S101). The logic synthesis unit 21 reads the RTL file 83 and the timing constraint file 84 (S102).

The logic synthesis unit 21 performs logic synthesis according to information included in the files that are read (S103). In this case, even when there is a control target flip-flop in a semiconductor integrated circuit targeted for logic synthesis, the logic synthesis unit 21 performs logic synthesis without inserting a clock gating cell. Then, the logic synthesis unit 21 creates the gate level netlist file 85 that is the result of the logic synthesis. The logic synthesis unit 21 stores the created gate level netlist file 85 in the storage device 8.

Next, the pseudo cell replacement/control information file generating unit 22 of the information reading unit 2 replaces cell-types of all of control target flip-flops included in the semiconductor integrated circuit with pseudo cells (S104). That is, the pseudo cell replacement/control information file generating unit 22 creates layout data in which the control target flip-flop is replaced with a pseudo cell according to the result of the logic synthesis. The pseudo cell is indicated by a cell-library in which only cell name of a cell-library of a standard flip-flop is arbitrarily changed to distinguish precisely the control target flip-flop and a flip-flop not controlled by an enable signal. In the cell-library of this pseudo cell, information other than the cell name among information included in the cell-library of the standard flip-flop is basically the same as the cell-library of the standard flip-flop. For example, information other than the cell name includes a function indicating AND logic or OR logic, drive capability indicating speed of signal transmitted to a subsequent stage, pin information indicating an input terminal and an output terminal, and so on.

Note that, the cell-library of the pseudo cell may have less information than the cell-library of the standard flip-flop. For example, in the cell-library of the pseudo cell, information that is unnecessary is eliminated from the cell library of the standard flip-flop until layout of a clock gating cell and CTS mentioned below are performed (S110). For example, the cell-library of the pseudo cell does not include information of an input terminal of a clock signal that is not used until layout of a clock gating cell and CTS are performed (S110). This enables to reduce the volume of information regarding a cell stored in memory until a cell is replaced again (S109) before layout of a clock gating cell and CTS are performed (S110) in the layout device 1. Thus, the amount of memory used to other applications can be increased, which enables to increase the processing speed.

Next, the pseudo cell replacement/control information file generating unit 22 creates the control information file 90 in which the control target flip-flop replaced by the pseudo cell corresponds to the enable signal controlling the control target flip-flop. The pseudo cell replacement/control information file generating unit 22 stores the created control information file 90 in the storage device 8 (S105). This enables to specify the control target flip-flop by only referring to the control information file 90 when the clock gating cell is inserted as described below (S108). Therefore, in the layout device 1, for example, there is no need to store information needed to specify the control target flip-flop in the memory, such as information regarding relation of connection of an enable signal wire in RTL. Thus, the amount of memory used to other applications can be increased, which enables to increase the processing speed.

Next, the floor plan performing unit 3 performs floor plan, and decides position of an I/O, chip size, and position of a circuit block such as hard macro (S106). Furthermore, the floor plan performing unit 3 includes information indicating the decided positions in the layout data.

Next, the standard cell laying out/optimizing unit 41 of the layout/CTS/optimization unit 4 lays out the standard cell while optimizing a logic circuit to meet timing constraint for the layout data in which the circuit block is laid out (S107). In this exemplary embodiment, the logic synthesis is performed without inserting the clock gating cell in step S103. This enables to lay out the standard cell excluding the clock gating cell without performing processing that recognizes or deletes the clock gating cell. Furthermore, the standard cell laying out/optimizing unit 41 decides the coordinate of the standard cell such as control target flip-flop. The standard cell laying out/optimizing unit 41 includes information indicating the decided coordinate in the layout data.

Next, the clock gating cell inserting unit 42 of the layout/CTS/optimization unit 4 inserts the clock gating cell in the layout data after the standard cell is laid out according to the control information file 90 (S108).

Note that, insertion processing of the clock gating cell (S108) is specifically explained. First, the clock gating cell inserting unit 42 obtains the control information file 90 from the storage device 8. Then, the clock gating cell inserting unit 42 obtains information block indicating the enable signal 91 and the control target flip-flop 92 controlled by the enable signal 91 for each of the enable signals 91 as one group (hereafter, referred to as a “large group”) from the obtained control information file 90.

Next, the clock gating cell inserting unit 42 extracts the coordinates of all of the control target flip-flops included in the large group from the layout data after the standard cell is laid out. Note that, the control target flip-flops 92 laid out adjacent to each other are included in one group (hereafter, referred to as a “small group”). Note that, “adjacent” means a predetermined range. For example, the predetermined range can be arbitrarily decided such as a range to meet the timing constraint of the clock signal. Furthermore, a small group may not always include a plurality of the control target flip-flops 92. The small group may include only one control target flip-flop 92.

Next, the clock gating cell inserting unit 42 inserts one clock gating cell for clock lines of all of the control target flip-flops 92 included in the same small group among the layout data. Then, the clock gating cell inserting unit 42 connects the enable signal to the inserted clock gating cell. In this way, it is possible to reduce the number of elements mounted on the semiconductor integrated circuit by using one clock gating cell. The clock gating cell inserting unit 42 inserts the clock gating cell for all of the large groups included in the control information file 90 in series, as described above.

The clock gating cell inserting unit 42 replaces cell-type of the control target flip-flop replaced with the pseudo cell with the standard cell-type (S109). That is, the clock gating cell inserting unit 42 replaces cell-type of the control target flip-flop with the cell-type before replacement in step S104.

Next, the clock gating cell layout/CTS performing unit 43 of the layout/CTS/optimization unit 4 performs layout of the clock gating cell and CTS for the layout data after insertion of the clock gating cell to structure a clock tree (S110). In this exemplary embodiment, in this step, the clock gating cell is laid out, and the clock tree is structured. Thus, it is possible to lay out the clock gating cell and a clock buffer in a position in consideration of low power consumption, and structure clock tree.

For example, the clock gating cell layout/CTS performing unit 43 lays out the clock gating cell near a clock root. This enables to structure the clock tree to lay out the clock buffer in the subsequent stage of the clock gating cell. That is, it is possible to prevent a situation that adjusting clock skew by laying out the clock buffer in the subsequent stage of the clock gating cell becomes difficult or impossible by laying out the clock gating circuit near a synchronous circuit such as a flip-flop. Thus, the clock signal is not supplied to the clock buffer, when the clock signal is not supplied to the subsequent stage of the clock gating cell by the enable signal. Thus, it is possible to reduce the electric power consumed in the clock buffer.

Next, the LOCKUP cell deleting/inserting unit 5 determines whether clock skew between flip-flops, each of which supplied with a clock signal from different clock lines, is sufficiently small in scan chain composed of a synchronous circuit such as the flip-flop included in the semiconductor integrated circuit for DFT (S111).

If the clock skew is sufficiently small, the LOCKUP cell deleting/inserting unit 5 determines whether a LOCKUP cell is inserted (S112). If the LOCKUP cell is inserted, the clock skew is sufficiently adjusted. Thus, the LOCKUP cell deleting/inserting unit 5 deletes the LOCKUP cell (S114).

If the clock skew is not sufficiently small, the LOCKUP cell deleting/inserting unit 5 inserts a LOCKUP cell to adjust the clock skew (S113).

Next, the timing optimizing unit 6 obtains the timing constraint 84 from the storage device 8. The timing optimizing unit 6 optimizes timing according to the content of the obtained timing constraint 84 (S115).

Next, the signal wiring unit 7 wires signal wire (S116).

As explained above, this exemplary embodiment performs logic synthesis without inserting a clock gating cell inserted into the semiconductor integrated circuit, and lays out a standard cell according to the result of the logic synthesis. Then, this exemplary embodiment inserts the clock gating cell after the standard cell is laid out, and lays out the clock gating cell and structures a clock tree. Therefore, in this exemplary embodiment, it is possible to eliminate the need to perform the clock gating circuit recognizing/deleting step because the clock gating cell is not inserted in the logic synthesis. Thus, the processing time can be reduced.

Furthermore, this exemplary embodiment inserts a clock gating cell after a standard cell is laid out, and lays out the clock gating cell and structures the clock tree. Thus, it is possible to control layout of the clock gating cell such that the clock gating cell is laid out in a position to achieve low power consumption, and structures the clock tree.

Furthermore, even if the clock gating circuit recognizing/deleting step is mounted in the layout device, this exemplary embodiment may not insert a clock gating cell in logic synthesis. In this case, the number of enable signals Y input for combinational circuits on clock lines is 0, and time taken for the clock gating circuit recognizing/deleting step is 0 hours because X×Y hour is 0 hours. Thus, it is possible to reduce processing time. In addition, it is possible to control layout of the clock gating cell such that the clock gating cell is laid out in a position to achieve low power consumption, and structures clock tree.

The present invention is not limited to the above exemplary embodiment, but can be modified as appropriate within the scope of the present invention.

For example, in this exemplary embodiment, not all of clock gating cells that will be inserted in the semiconductor integrated circuit are inserted in logic synthesis. However, at least one of all of clock gating cells may be inserted, and the non-inserted clock gating cell may be inserted after the standard cell is laid out.

The layout device explained above according to the exemplary embodiment of the present invention can also be configured by supplying a computer readable media, which stores a program for implementing the function according to the exemplary embodiment of the present invention, to a system or device, and by causing a computer, a CPU, or a MPU (Micro Processing Unit) included in the system or device to execute the program.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the function according to the above exemplary embodiment can be implemented by causing a computer to execute a program for implementing the function according to the exemplary embodiment, the function according to the exemplary embodiment can also be implemented in the following case. That is, the function according to the exemplary embodiment can be implemented in cooperation with an operating system (OS) or application software such as EDA tool running on a computer, in response to an instruction from the program.

Moreover, the function according to the exemplary embodiment can also be implemented when all or a part of the processing for the program is executed by a function extension board inserted into a computer or a function extension unit connected to a computer.

While the invention has been described in terms of several exemplary embodiment, those skilled in the art will recognize that the invention can be practiced with various modifications within the spirit and scope of the appended claims and the invention is not limited to the examples described above.

Further, the scope of the claims is not limited by the exemplary embodiment described above.

Furthermore, it is noted that, Applicant's intent is to encompass equivalents of all claim elements, even if amended later during prosecution.

What is claimed is:

1. A layout method to perform layout of a semiconductor integrated circuit, the layout method comprising:
performing logic synthesis without inserting at least one clock gating cell among clock gating cells inserted in the semiconductor integrated circuit;
laying out a cell according to a result of the logic synthesis;
inserting the clock gating cell not inserted in the logic synthesis after the cell is laid out; and
laying out the inserted clock gating cell, and structuring a clock tree.

2. The layout method according to claim 1, wherein the layout method further comprises:
generating a control information in which an enable signal corresponds to a control target cell controlled by the enable signal, and storing the generated control information in a storage unit;
wherein in inserting the clock gating cell, the clock gating cell is inserted for the control target cell according to control information stored in the storage unit.

3. The layout method according to claim 2, wherein in inserting clock gating cell, one clock gating cell is inserted for control target cell, controlled by the same enable signal and laid out in a predetermined range among the control target cells indicated by the control information.

4. The layout method according to claim 2, wherein the layout device further comprises:
replacing the control target cell included in a result of the logic synthesis with a pseudo cell, the pseudo cell having less information than the control target cell;
wherein when the inserted clock gating cell is laid out and the clock tree is structured, the pseudo cell is replaced with the control target cell.

5. The layout method according to claim 2, wherein the control information is the information in which an instance name of the control target cell corresponds to an enable signal name.

6. The layout method according to claim 2, wherein the control target cell is a flip-flop.

7. A layout device to perform layout of a semiconductor integrated circuit, the layout device comprising:
a logic synthesis unit that performs logic synthesis without inserting at least one clock gating cell among clock gating cells inserted in the semiconductor integrated circuit;
a cell laying out unit that lays out a cell according to a result of the logic synthesis;
a clock gating cell inserting unit that inserts the clock gating cell not inserted in the logic synthesis after the cell is laid out by the cell laying out unit; and
a clock gating cell layout/tree structure performing unit that lays out the clock gating cell inserted by the clock gating cell inserting unit, and structures a clock tree.

8. A non-transitory computer readable medium storing a layout program performing layout of a semiconductor integrated circuit, the layout program causing a computer to execute the processing of:
performing logic synthesis without inserting at least one clock gating cell among clock gating cells inserted in the semiconductor integrated circuit;
laying out a cell according to a result of the logic synthesis;
inserting the clock gating cell not inserted in the logic synthesis after the cell is laid out; and
laying out the inserted clock gating cell, and structuring a clock tree.
